(19) United States
(12) Patent Application Publication
(10) Pub. No.: US 2012/0162761 A1
(43) Pub. Date: Jun. 28, 2012

(54) AUTOSTEREOSCOPIC DISPLAY

(75) Inventors: Armin Grasnick, Singapore (SG); Ambrose Peter Nari, Bandar Puteri Puchong (MY)

(73) Assignee: Idyllic Spectrum Sdn Bhd

(21) Appl. No.: 13/084,888

(22) Filed: Apr. 12, 2011

Related U.S. Application Data
(63) Continuation-in-part of application No. 11/940,473, filed on Nov. 15, 2007, now abandoned.

(51) Int. Cl. G02B 27/22; B29C 65/00

(52) U.S. Cl. 359/462; 156/60

(57) ABSTRACT

A method for creating an autostereoscopic display device including the steps of:
providing a display array with a defined pixel arrangement for a number of views (nᵥ), and
providing a parallax barrier that is arranged before and/or behind the display array, wherein the parallax barrier structure is designed with a plurality of structural elements distributed over a barrier surface, whereby a barrier texture is formed by the totality of structural elements which runs skew over the barrier surface,
each individual structural element being positioned on the barrier surface based on a virtual raster which is distributed over the barrier surface, the virtual raster is comprised of individual anchoring boxes, wherein a centre of each anchoring box defines the position of one of the totality of the structural elements on the barrier surface, and
the anchoring boxes being scaled with a correction factor that is based on the display device and the number of views (nᵥ),
wherein the display array and the parallax barrier are aligned and fixed to each other.

### RELATED APPLICATIONS

The present application is a Continuation-in-Part (CIP) of U.S. application Ser. No. 11/940,473 filed Nov. 15, 2007 which is fully incorporated herein by reference.

### FIELD OF THE INVENTION

The invention refers to an autostereoscopic display device and more particularly to the method of making such.

### BACKGROUND OF THE INVENTION

Autostereoscopic display devices, in particular flat or screen displays, allow for a stereoscopic presentation of a three-dimensional object, which does not require any additional viewing aids like special spectacles and similar items.

For screen and/or flat displays with a defined arrangement of picture points—i.e. pixels and/or sub pixels—array-induced arrangements from a parallax-barrier are used which are arranged before or behind the actual display. In this regard the parallax-barrier is a simple optical system which—together with the defined pixel arrangement, e.g. a LC-display, a plasma-display, an OLED display or even a conventional cathode ray display—, imparts to a control unit, e.g. a computer, and suitably edited image data an autostereoscopic picture impression to a viewer who is seated before the display device in the case of a parallax barrier the viewing of specified image data through a suitable arrangement of transparent and translucent, i.e. opaque section can be allowed or refused. This transparent/opaque structure forms the parallax structure of the parallax barrier and is adjusted to the display.

The allocation of the parallax structure to the relevant image data on the display depends on the position of the viewer. An autostereoscopic picture impression can only take place if at least two image data can be binocularly and stereoscopically experienced in a viewer position. This can be achieved with the parallax-barrier. It can be located either before or behind the display system. The latter design form is preferred for transparent and/or translucent display forms.

Such arrangements are characterized as “array-induced arrangements” and results from the design of the parallax-barrier—and also the entire display device—being ultimately built on the array of the individual pixels and subpixels in the display, and are determined by this array. As a result, a description of the array entails a description of the all display devices that are dependent thereon, and also on the parallax-barrier, which quasi “induces.”

Parallax-barriers were, for example, described by Jacobson and Bertiher 1896, Frederick E. Ives 1903, Estenave 1906 and Clenernce W. Kanolt 1915 primarily in connection with printing techniques and films. The currently used parallax-barriers in the display technique represent transpositions of commonly used barrier arrangements from these sectors, which can, for example, be used on flat display. S. P. Ivanof and Herbert E. Ives have already suggested in the middle of the 20th century a number of improvements. An extensive “Theory of Parallax-Barrier” was published in 1952 by S. H. Kaplan, wherein all at that time available current barrier-technologies are, in essence, fully disclosed. A rather extensive description of 3D-display-technologies, including a list of literature of further publications, can be found under the Hollmann URL

http://www.dur.ac.uk/n.s.hollmann/Presentations/3dv3-0.pdf

A considerable problem with the current forms of parallax-barriers is on for once the not insignificant loss of intensity of the display. In this case, proportional to the view count on the display unit, at least ½ of the initial intensity of the display is suppressed due to the barrier structure and the exact positioning of the transparent and opaque sections on the barrier surface. In the currently used barrier systems, these correspond generally to the structure of the pixel on the array of display, which is projected on the barrier system, whereby, especially the rectangular or square pixels and sub-pixels forms, are transferred onto the barrier structure. Examples for this are the parallax barriers of Messrs. Sanyo, Sharp or 4D-Vision.

The thus produced parallax barriers consist of vertical arrangements of strips or transverse-running, stair-like arrangements from transparent and/or opaque sections, in which case—due to the angled and star-like form—overlays may appear, particularly Moiré-designs, but other interferences or diffractions may also occur, which often drastically impair the image quality.

Another disadvantage of the currently used barrier systems is that for the angular arrangement of transparent structures, in horizontal as well as in vertical direction, attention must be paid to very precise and non-rotating positioning of structures. This entails a relatively costly installation of the parallax-barrier, which cannot always be solved in a satisfactory manner.

The task is, therefore, to specify a method to create an autostereoscopic display device from a screen array with defined pixel arrangements and a parallax barrier which is located in front and behind the screen array, in which the positioning of the opaque and/or transparent barrier structures, and thereby the entire parallax barrier, can be carried out easily, realized easily and can be pre-determined and which will—because of to the installed parallax barrier—only slightly affect the quality of the image presentation.

This task is solved with a method for creating an autostereoscopic display device with the features of the claims. The sub-claims contain functional and/or expedient design forms in accordance with the invention.

According to the invention the autostereoscopic display device is distinguished by having a parallax-barrier showing a totality of structural elements which are distributed across a barrier surface. On account of the structural elements a barrier texture is formed which consists of rows of smooth barrier line running skewed over a barrier texture.

### SUMMARY OF THE INVENTION

According to the invention, the structural elements form a parallax barrier, basic elementary transparent or opaque basic forms, from which the barrier structures are composed. These are distributed across the barrier surface in such a way that their line-up forms a row of barrier lines running skewed across the barrier surface. Due to the design of the structural elements, the barrier lines do not run in a stair-like or zigzag manner, as is the case in conventional parallax barriers with rectangular, opaque or transparent holes or transparent sections; but the barrier lines are formed—more or less strongly—vis-à-vis lines and/or strips, which are inclined towards the vertical, without any step—or zigzag structure. As a result the interfering diffractions which are encountered in the zigzag and/or step edges are completely omitted. The barrier texture formed by these lines consists of a totality of such parallel running barrier lines, which are distributed over the entire barrier surface.

Due to the particular design of the skewed barrier elements, only one precise and distortion-free installation in horizontal direction is necessary, which considerably simplifies the positioning of the parallax barrier.

In principle the appearance of the mentioned barrier texture is determined by the position and arrangement of the individual structural elements. If the invention is advantageously designed by the inventive method for creation of an autostereoscopic display, the position of each individual structural element is determined by a virtual raster, consisting of individual anchoring boxes, which are distributed over the barrier surface, whereby a centre of each anchoring box determines the place of the structural element on the barrier surface.

Under the inventive method, the anchoring boxes and the raster created by these forms, have two functions. For one, the form of each anchoring box indicates an enveloping limitation of each structural element. On the other hand, each anchoring box can be addressed via its centre. The raster is formed by the anchoring boxes and covers the entire barrier surface and can be scaled and distorted at random in a functional and simple manner, whereby the position and form of the structural elements are defined and determined in a suitable manner.

For this purpose the anchoring boxes are arranged on the barrier surface according to the pertinent picture allocation regulations pertaining to pixel arrangement of the display array and scaled with a correction factor that describes the geometric display and viewing parameter.

The places of the individual structural elements and course of the barrier lines and with this the design of the barrier texture, must be defined in view of the view count to be achieved for the display device and the given design of the display array, i.e. the position of the pixels and subpixels. The relevant picture allocation regulation of the individual images on the display array must be taken into consideration and transferred into the allocation regulation for the positions of the structural elements on the barrier surface. The allocation regulation thus obtained serves as basis for the positioning of the anchoring boxes of the virtual raster and, thus, also for the design of the raster itself. The scaling of the raster and also the anchoring boxes takes into consideration the geometric conditions given for creating a particular display, e.g. a distance between a display layer and a carrier surface for the parallax barrier, a rated distance for a viewing position and similar parameters.

In an expedient design form, the distribution of the rhomboid structural elements with a viewing count of 5 is adjusted to the following parameters: addition number of views for each gap=1, addition number of views per line 1, repetition number of views in x-direction=1, repetition number of views in y-direction=1.

The barrier surface is purposely designed as a transparent carrier substrate with a barrier foil that is laminated onto the carrier substrate. The barrier foil itself consists of an appropriate design of exposed film material. The barrier texture is formed as exposed dark opaque-light transparent structure. Alternatively, it can be printed using various printing techniques. The print is carried out onto a carrier substrate such as glass.

According to the invention the display device should in the following be further explained by using samples of the operation in conjunction with figures. For the same and/or same-acting parts the same reference symbols are used. Details show:

### BRIEF DESCRIPTION OF THE DRAWINGS

FIG. 1—A descriptive presentation for the definition of pixel width and pixel height,

FIG. 2—A descriptive presentation for defining a subpixel and the width of a subpixel

FIG. 3—A basic presentation of a display array with an indexing of subpixels contained in the array

FIG. 4—An exemplary presentation of a segment of a virtual raster with anchoring boxes with barrier lines,

FIG. 5—An exemplary presentation of a segment of a virtual raster with anchoring boxes and samples of rhomboid structural elements which are positioned in the anchoring boxes.

FIG. 6—An additional exemplary presentation of the virtual raster with rhomboid structural elements.

FIG. 7—Samples of hexagonal and cross-shaped structural elements.

FIG. 8—A schematic presentation of geometrical conditions in the system of the display array, the parallax barrier an the viewing position

FIG. 9—A schematic presentation for the derivation of a correction factors of a barrier structure.

FIG. 10—A presentation of gap width and gap pitch of the parallax barrier.

FIG. 11 is a plan view of a Fresnel structure, in particular, a zone plate.

FIG. 12 is a plan view of a Fresnel structure, in particular, a spiral.

FIG. 13A is a plan view of a rectangular structural element.

FIG. 13B is a plan view of an octagonal structural element.

FIG. 13C is a plan view of a parallelogram structural element.

FIG. 13D is a plan view of a star-shaped structural element.

FIG. 13E is a plan view of an elliptical structural element.

FIG. 13F is a plan view of a circular structural element.

FIG. 13G is a plan view of 1-bit-bitmap texture.

FIG. 14 is a plan view of a viewer's eye.

FIG. 15 is a schematic presentation of a super multiview combination for an autostereoscopic display device according to one embodiment of the present invention.

### DETAILED DESCRIPTION OF THE INVENTION

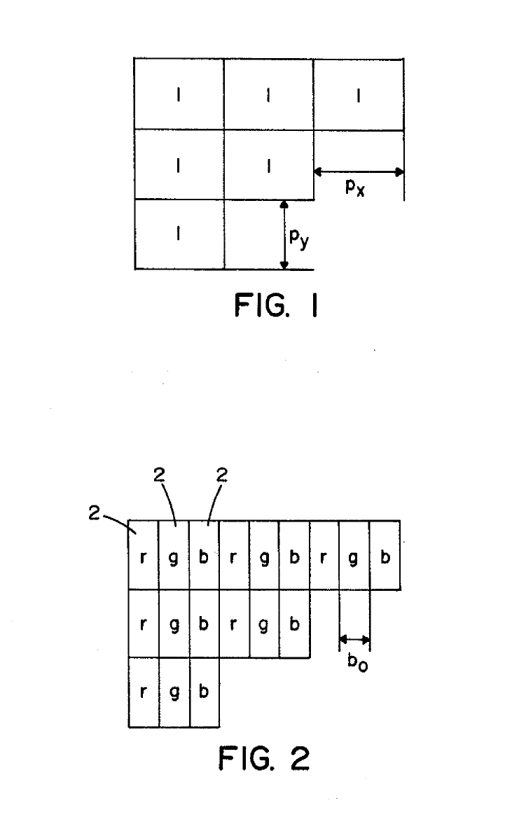

FIG. 1 shows and explains a group of schematic pixels 1 with a horizontal pixel width pₓ and a vertical pixel height of p_{y}. In a colour display the colour value of each pixel is known to be produced by mixed colour additives. As shown in FIG. 2, each pixel is divided into 3 subpixel 2, which radiate a colour value red r, green g and or blue b in different grades of brightness. These sub pixels can be individually accessed and, thus, form the elementary raster element of the display surface. The size of these raster elements is determined by the pixel height p_{y} and by the subpixel width bₒ. The subpixel width bₒ plays a particularly important role. The subpixels can, technically speaking, be produced as elements of a LC-display, a plasma display or even as part of a conventional electron beam display.

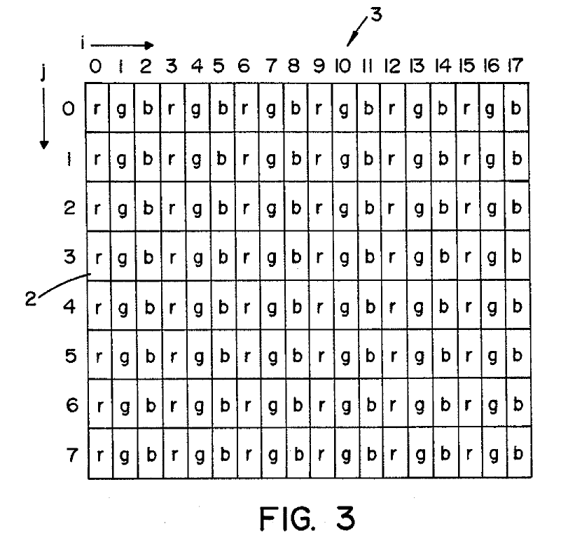

FIG. 3 shows a segment of a display array 3 with a row of red subpixels r, green subpixels g and blue subpixels b. The position of each individual subpixel of the array is clearly defined by indexing. The sample shown here begins with horizontal numbering i at a value of i=0 and ends with i=17. A vertical numbering j of the subpixels begins in this sample at j=0 and continues until j=7. It follows that for an nₓ*n_{y} array with nₓ subpixels in horizontal and n_{y} subpixels in vertical direction, the horizontal numbering of the raster elements from i=0 until i=nₓ−1 and the vertical numbering in a corresponding manner from j=0 until j=n_{y}−1. This index system (i; j) clearly describes the array and forms the basis for the design of the parallax barrier.

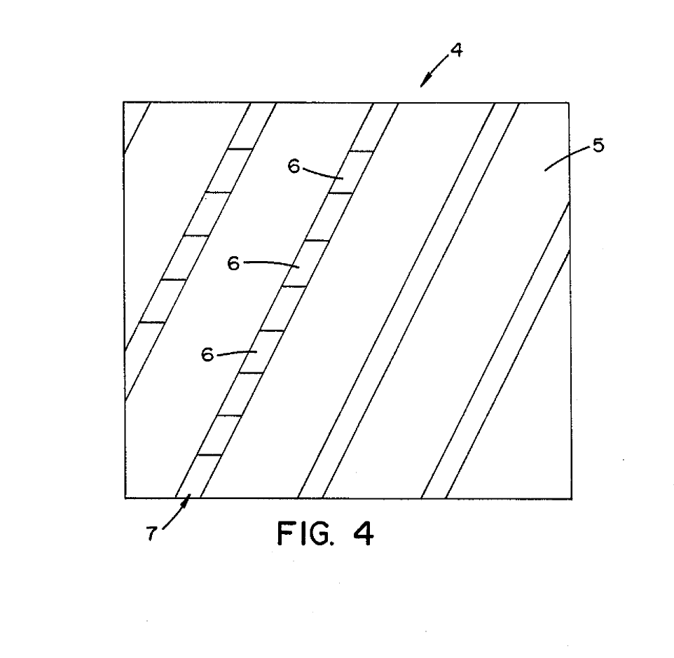

FIG. 4 shows a sample of a segment of a parallax barrier 4 in accordance with the design of the invention. The parallax barrier shows a barrier surface 5 with a barrier texture that is alternating between opaque and transparent. The individual elements of the barrier texture are composed of a row of rhomboid structural elements 6, which are grouped along skew barrier lines 7. The barrier lines and also the structural elements can be transparent or opaque. The sectors of the barrier surface located between the barrier lines possess appropriate contrasting properties. Without limiting the totality, it is assumed from the following design examples that the structural elements are translucent and arranged on an otherwise opaque barrier surface.

The parallax barrier is, for example, formed in the shape of a transparent carrier, which exhibits only negligible dispersion. For instance, a security glass or an EMV protective glass may be used for this purpose. A barrier foil is laminated on to this carrier, which is expediently formed as a black-white film, which—by using laser exposure—was provided with the relevant barrier textures. The carrier surface with the barrier foil is in the following referred to a barrier surface.

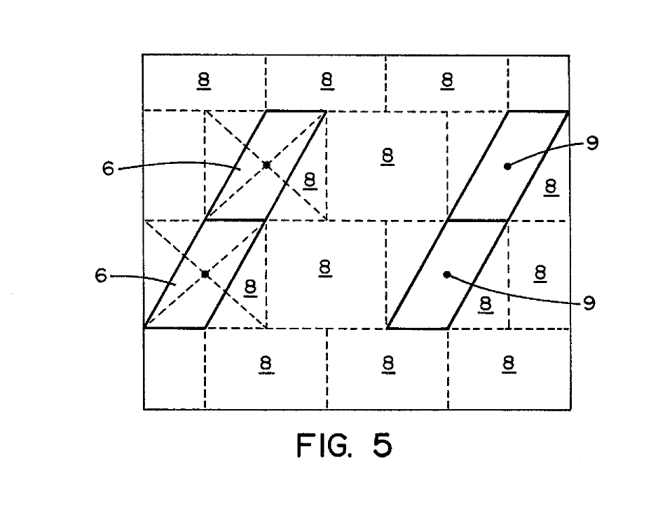

FIG. 5 shows a sample arrangement of the structural elements in conjunction with a row of anchoring boxes 8 on the barrier surface. The totality of the anchoring boxes, which are also referred to as “bounding boxes”, forms a virtual raster or lattice which are transferred on to the barrier surface, in which the structural elements are inscribed. In the example shown here, the anchoring boxes consist of rectangles in a wall-like arrangement. Their centers 9 mark their position on the barrier surface. The position is described for this purpose in an allocation regulation, which can be referred to as the allocation regulation for raster elements of the display surface, i.e. the above-mentioned indexing of subpixels and their geometric form.

The very shape of the anchoring boxes determines the form of the inscribed structural elements. According to the arrangement of the parallax barrier and the geometric conditions of use (in front and behind the display surface, the appropriate viewing distance, the size of pixel and/or subpixel, the space between the barrier surface of the display surface and the eye distance of the viewer which as an average is 65 millimeters) result in a row of corrections, in particular correction factors, with which the virtual lattice of the anchoring boxes is to be scaled. In conclusion it can be noted that the position of the structural elements is determined by the centre of the anchoring boxes, while the shape of the structural elements, i.e. their size, incline, width and form, are determined by the scaling of the anchoring boxes.

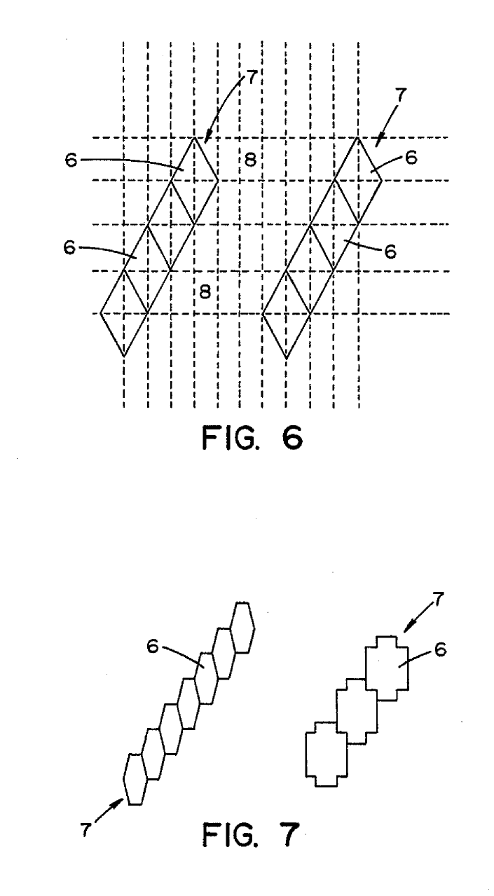

It is understood that the structural elements can show variable interior angles and that the structure of the virtual grates of the anchoring boxes can also be changed. FIG. 6 shows an example hereto. In this example the anchoring boxes form a rectangular lattice, while the structural elements are rhombus-shapes which are standing on their corners. Each corner of the rhombi shown here is described by a lattice point of the anchoring boxes and is, thus, defined by the structure of the virtual lattice. The centres of the rhombi are also determined by the virtual lattice points. It is obvious that by scaling the lattice as well as by stretching or swaging of the lattice, the shape of the rhombi and their location can be changed. By comparing the illustration in FIG. 6 with the illustration in FIG. 5 and the picture of FIG. 4 it becomes apparent that the skew barrier lines of FIG. 4 can be realized through the design form as in FIG. 5 and also through the design of the structural elements as in FIG. 6.

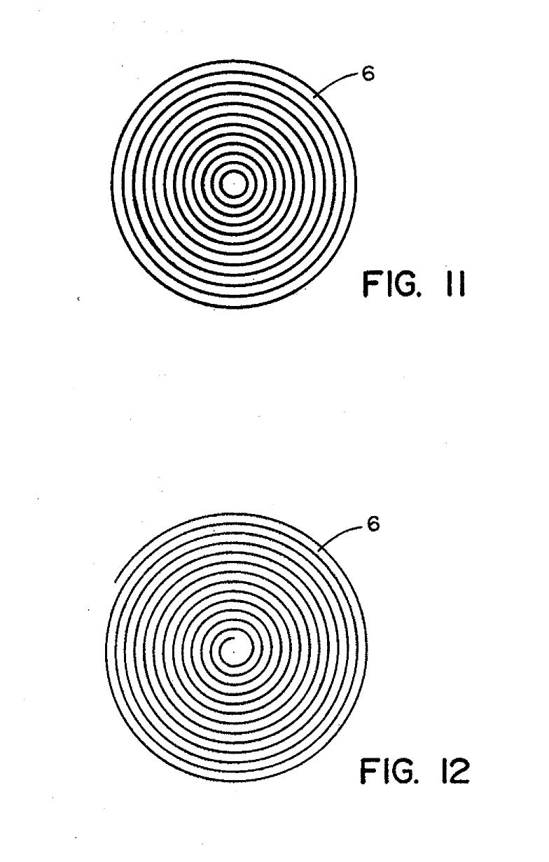

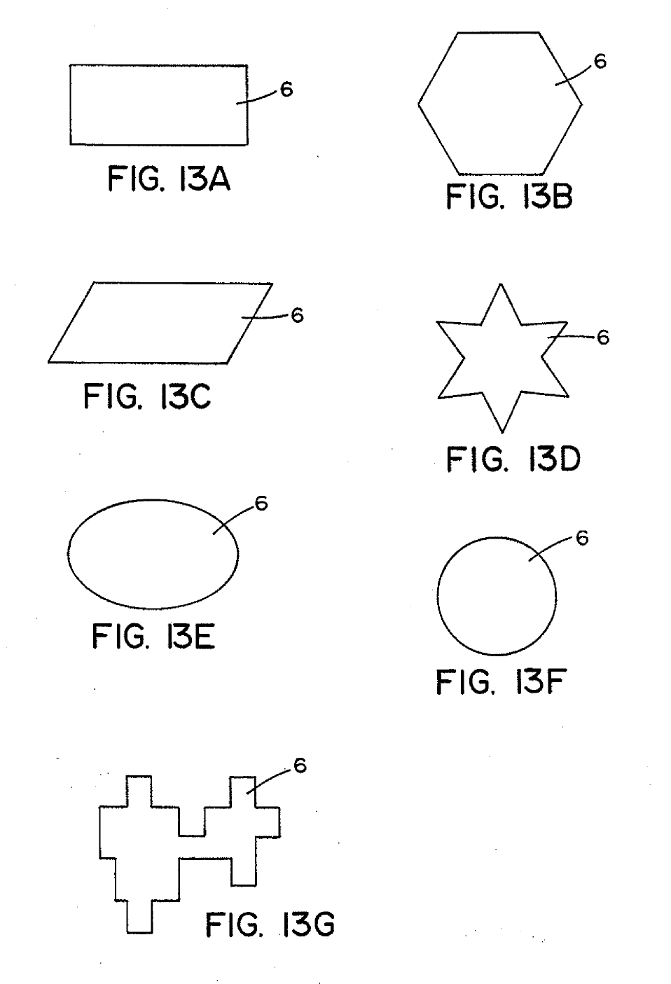

In a more general approach, not a parallax barrier but rather an optical element is formed in course of another embodiment of the inventive method. For this purpose rectangular, octagonal, parallelogram, star-shaped, elliptic or even circular structural elements (as shown in FIGS. 13A-13F) can be used on the optical element (which is a more general term for a parallax barrier). 1-bit-bitmap-textures (as shown in FIG. 13G) or combinations of form and bitmap-structures, like for example Fresnel structures such as zone plates, circles or spirals (as shown in FIGS. 11 and 12) can also be sued and can be used for support. Holographic objects can also be used as structural element.

With regard to the presentation in FIG. 5 it must be pointed out that the structural elements can, in principle, take on any random geometric form. When choosing the form thereby created, the purpose of the barrier structure must be taken into consideration. The presentation on the left of FIG. 7, for instance, shows an arrangement of structural elements in a hexagonal form, while presentation on the right in FIG. 7 shows structural elements in a cross form, which are purposely lined up together. The rhombus form of the structural elements as shown in FIG. 6 and/or the structural elements in the form of a rhomboid as shown in FIG. 5 appear to be most expedient with regard to the skew, smooth barrier lines shown in FIG. 4.

Moreover, it must be noted that even rectangular and/or square structural elements can be used to produce vertical barrier structures.

In the following the correction and the adjustment of the shown parallax barrier on the respective display will be explained further. Examples of alignment methods for aligning the parallax barrier relative to the respective display are disclosed in U.S. Patent Application Publication Nos. 2010/0220325 A1 to Otte et al. entitled “Method for Orienting an Optical Element on a Screen” and 2006/0050382 A1 to Jahrmarkt et al. entitled “Method for the Protection of 3D Screen” and International Patent Application Publication No. WO 2010/046234 A1 to Klippstein entitled “Method for Positioning an Optical Element on an Image Reproduction Device,” the disclosure of each of the foregoing documents being hereby incorporated herein by reference. FIG. 8 shows, for this purpose, a simplified presentation of the geometric proportion in a display device with parallax barrier. In the example shown here, the parallax barrier M is located between the display surface B and the viewing level Z. The subpixel illuminating the display surface are viewed through a gap S, i.e. through the transparent section of the parallax barrier. As long as the parallax barrier is placed behind the display surface and is illuminated through a light source in the rear, the conditions shown here in FIG. 8 do not change at all. The following deliberations are based on the intercept theorems, and can also be used for such a configuration and retain their validity.

FIG. 8 shows an example where the parallax barrier M is located at a distance aₘ before the display surface B. The distance aₘ is referred to as mask width. The viewing plane Z, —i.e. the plane in which the eyes of the viewer are located—is located at a distance a_{z} before the parallax barrier. This distance is called the viewing distance.

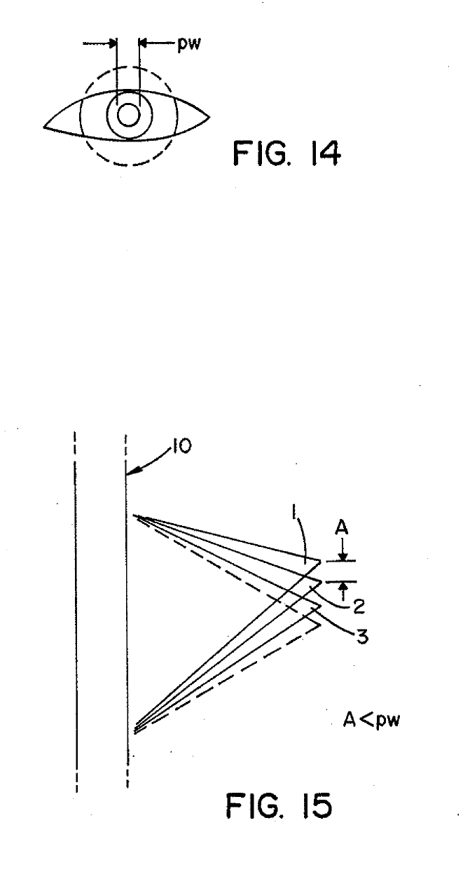

The width of an individual subpixel bₒ is projected via the gap S of the parallax barrier M on a projection width A in the viewing plane Z. For lower viewing counts the value of A is generally identical with the average eye distance of the viewer. According to one embodiment of the present invention, shown in FIGS. 14 and 15, an autostereoscopic display device 10, which should fulfill the requirement that with this a large number of views in a so-called “super multi-view condition” should be shown, the projection width A takes on values, which are normally smaller than the entry pupil of the viewer's eye p_{w}. Said pupil of an eye has, under normal viewing and physiological conditions, diameters of few millimetres, often between 1 to 5 millimeters.

The connection between the mask width am, the subpixel width bₒ, the projection width A and the viewing distance a_{z} is given through the intercept theorem with the following proportional equation:

$$\frac{{b}_{o}}{{a}_{m}} = \frac{A}{{a}_{z}}$$

If A, bₒ and a_{z} are known, the mask width is calculated through the relation

$${a}_{m} = \frac{{b}_{o} {a}_{z}}{A} \qquad ( 1 )$$

At a projection width A=65 mm which is the average distance between the eyes of a viewer, the width of the subpixels bₒ=0.181 mm and the viewing distance a_{z}=4500 mm the resulting mask widths, for example, would be aₘ=12.5 min. One could also obtain the same value by exchanging the positions of the parallax barrier and the display surface and assuming there is an illuminated barrier.

For the design of the parallax barrier the envisioned viewing count nᵥ is of utmost importance. A single stereoscopic view is equivalent to a two-dimensional take of a picture motive from a defined position. The higher the viewing count, the more realistic is the impression of the shown stereoscopic picture that can be realized by the display device. Depending on the quality of the display device, the views are distributed on the array of the display surface by using a row of parameters. The data record that combines the different views and the information of which is displayed on the display surface, contains a row of parameters qA, qB, qX and qY, which describe the arrangement of the views in the data record. These parameters can be numerical constants, but also suitable functions, which can, for example, depend on the indices i and j.

qA indicates the addition of a view for each display gap, qB indicates the addition for each display line. The values qX and qY refer to the repeat of views in x- and/or y-direction. For example, a qA=1 and a qB=1 is an addition to a view in one gap each, while a qX=1 and/or qY=1 refers to a repeat rate of one view each in x- and/or y-direction. In order to guide data records with this parameter set on to a given display surface to a suitable impression for the viewer, it is necessary adjust the parallax barrier to these presentations. With regard to the patterns shown in FIGS. 5, 6 and 7, this means that the barrier lines, the barrier surface and also the entire virtual net from the anchoring boxes must be scaled with these defined structural elements and adjusted on to the display.

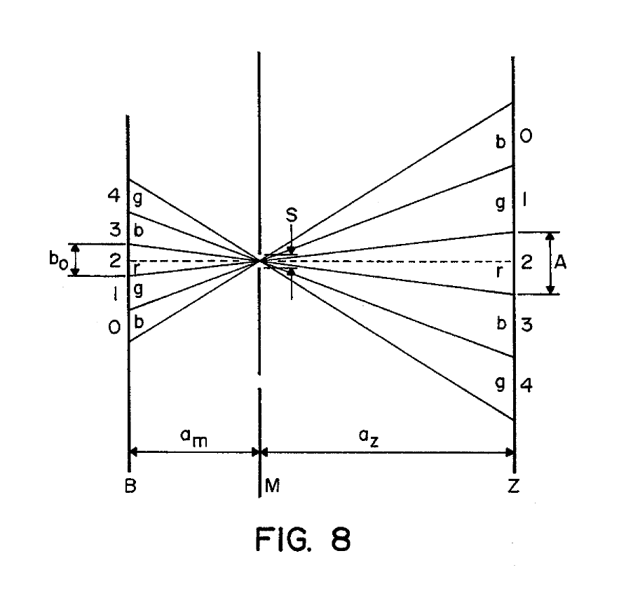

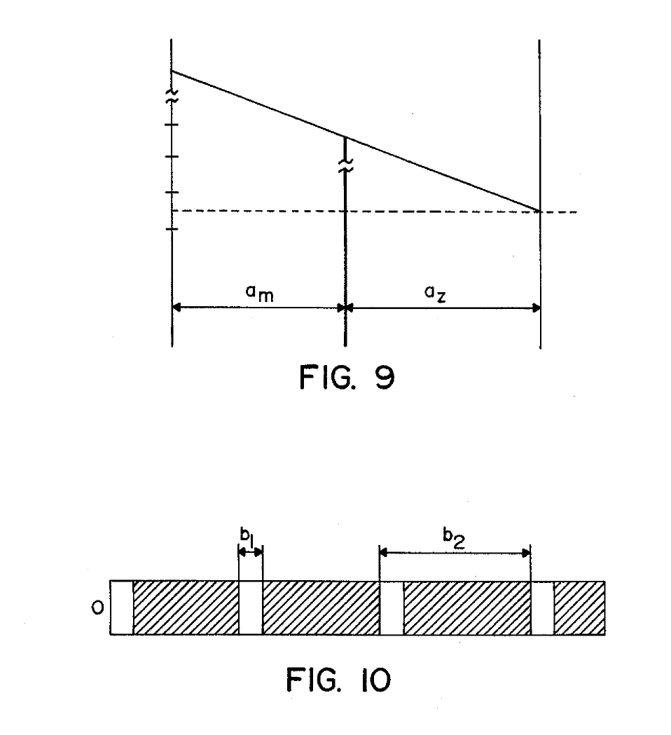

FIG. 9 shows a sample sketch for determining a correction factor for a barrier structure, which is used for the scaling of the anchoring boxes and structural elements. For the scaling it is necessary to adjust the gap width of the transparent sections of the barrier surface and the so-called gap pitch

FIG. 10 illustrates these basic barrier parameters. The gap width b₁ describes the width of a “window”, through which a pixel and/or a subpixel of the display surface can be viewed through the barrier and/or through which the pixel and/or subpixel will be illuminated. The gap pitch b₂ refer to a “lattice constant” of the barrier and is correlated with viewing count of the display device and or with the data record shown on the display surface, especially with the above mentioned parameters qA, qB, qX and qY.

The correction factor K essentially describes the centric extension of the pixel width as shown in the image geometry in FIG. 9. Under these conditions the following applies for the correction factor:

$$K = \frac{{a}_{z}}{{a}_{z} + {a}_{m}} \qquad ( 2 )$$

Together with the above-mentioned equation (1) the following applies:

$$K = \frac{{a}_{z}}{{a}_{z} + \frac{{b}_{o} {a}_{z}}{A}} = \frac{A}{A + {b}_{o}} \qquad ( 3 )$$

For example, at a value of A=65 mm and bₒ=0.181 mm the resulting value of K=0.997. The mentioned gap width and/or gap pitch is scaled with this value.

The scaled value for the gap width b₁ is arrived at by using the subpixel width bₒ and the correction factor K, taking into account

b₁=bₒK (4)

respectively

$${b}_{1} = \frac{{Ab}_{o}}{A + {b}_{o}} \qquad ( 4 a )$$

The gap pitch b₂ is arrived at by using the viewing count nᵥ and the thus determined gap width b₁ by taking into account

b₂=b₁nᵥ (5)

respectively

$${b}_{2} = \frac{{Ab}_{o}}{A + {b}_{o}} {n}_{v} \qquad ( 5 a )$$

For the scaling of the above described anchoring boxes reference is made to the computation of the view counts at the subpixel position with an index pair (i, j). This view count is computed as a value V, whereby the following connection exists:

$$V = {n}_{v} FractPart \frac{IntPart \frac{i}{qX} qA + IntPart \frac{i}{qY} qB}{{n}_{v}} \qquad ( 6 )$$

In this case i and j are the previously mentioned indices of the subpixels on the display and qA, qB, qX and qY are the parameters for arranging the views within the data record. The connection (6) fully describes a picture screen content for an autostereoscopic display, where the picture presentation is determined by parameter sets i, j, qA, qB, qX and qY. The function FractPart refers to the uneven-number part of the expression shown within the brackets, while the function of IntPart refers to the even-number part of expression in the bracket.

For the exact computation of the position of the structural elements on the carrier surface, reference is again made to the equation (6). All-here assumed to be transparent-structural elements within the anchoring boxes on the opaque barrier surface are placed with their centers on the positions with the same view count, for example on the positions of view 0, 1, 2 etc. In that case the maximum number of index elements i and j can deviate from the number of raster elements on the, i.e. subpixel, display surface.

The absolute position of the anchoring box for each structural element is derived at by multiplying the actual value for the running index I with the width bₒ of the raster element in horizontal direction and by multiplying the actual value for the running index j with the pixel height p_{y} in vertical direction.

The concluding adjustment of the thus produced structure of the parallax barrier is arrived at by scaling the anchoring boxes and, thus, also the structural elements by using the described correction factor K. In principle, the scaling has the effect of a centric stretching of the virtual raster, at least in the direction of the horizontal or vertical.

Predominant, however, is to retain the picture ratio in respect of the horizontal direction to the vertical direction of a virtual raster.

The invented device is explained by using samples of the various style forms. It is obvious that—in the context of expert handling and taking into consideration the sub-claims—further style forms can be designed, which are not the result of the fundamental ideas of this invention.

### REFERENCE SYMBOL LIST

1. Pixel
2. Subpixel
3. Display array
4. Parallax barrier
5. Barrier surface
6. Structural element
7. Barrier line
8. Anchoring box
9. Centre
10. Autostereoscopic display device
A Projection Width
aₘ Mask width
a_{z} Viewing distance
bₒ Subpixel width
b₁ Gap width
b₂ Gap pitch
i Horizontal run index
j Vertical run index
K Correction factor
nᵥ View count
pᵥ Pixel height
p_{w} Diameter of pupil of a viewer's eye
qA Additional number for each gap
qB Additional number for each line
qX Repetition number in x-direction
qY Repetition number in y-direction

Having described the invention, the following is claimed:

1. Method to create an autostereoscopic display device comprising the following steps:
providing a display array with a defined pixel arrangement for a number of views (nᵥ), and
providing a parallax barrier, which is arranged before and/or behind the display array, wherein the parallax barrier structure is designed with a plurality of structural elements distributed over a barrier surface, whereby a barrier texture is formed by the totality of structural elements which runs skew over the barrier surface,
each individual structural element being positioned on the barrier surface based on a virtual raster which is distributed over the barrier surface, the virtual raster is comprised of individual anchoring boxes, wherein a centre of each anchoring box defines the position of one of the totality of the structural elements on the barrier surface the anchoring boxes also being positioned on the barrier surface in accordance with a suitable picture allocation regulation for the number of views (nᵥ) and in accordance with the defined pixel arrangement of the display array, and
the anchoring boxes being scaled with a correction factor that is based on the display device and the number of views (nᵥ) wherein the correction factor has the effect of a centric stretching of the virtual raster in the horizontal or vertical direction, such that the shape of the totality of structural elements is defined by the scaling of the anchoring boxes is a plurality of skewed, smooth barrier lines, and
wherein the display array and the parallax barrier are aligned and fixed to each other.

2. Method pursuant to claim 1, wherein an enveloping limitation of each structural element is dimensioned to form parallel running barrier lines on the barrier texture.

3. Method pursuant to claim 1, wherein the enveloping limitation of each structural element is rectangular, octagonal, star-shaped, elliptic, circular, 1-bit-bitmap textures or combinations of form and bitmap structures.

4. Method pursuant to claim 1, wherein the barrier surface includes a transparent carrier substrate with a laminated barrier foil.

5. Method pursuant to claim 1, wherein the barrier surface includes a barrier foil made of an exposed film material, wherein the barrier texture is formed on the barrier surface is an exposed darkish opaque/light transparent structure.

6. Autostereoscopic display device comprised of
a display array with a defined pixel arrangement for a number of views (nᵥ); and
an optical element which is arranged before and/or behind said display array, said optical element including a totality of structural elements distributed over the surface of said optical element whereby an optical texture is formed by said totality of structural elements,
each individual structural element being positioned on the optical element's surface based on a virtual raster which is distributed over the surface, the virtual raster is comprised of individual anchoring boxes wherein a center of each of said anchoring boxes defines the position of one of said totality of structural elements on said optical element, the anchoring boxes also being positioned on the optical element's surface in accordance with a suitable picture allocation regulation for the number of views (nᵥ) and in accordance with the defined pixel arrangement of the display array,
the anchoring boxes being scaled with a correction factor that is based on the display device and the number of views (nᵥ) wherein the correction factor has the effect of a centric stretching of the virtual raster in the horizontal or vertical direction such that the shape of the totality of structural elements is defined by the scaling of the anchoring boxes, and
wherein some or all of the totality of structural elements are Fresnel structures, such as zone plates, circles or spirals, or as holographic objects.

7. Method to create an autostereoscopic display device pursuant to claim 1, wherein the totality of structural elements within the anchoring boxes on the barrier surface are placed with the center of each structural element being placed in positions that have an identical view count.

8. Method pursuant to claim 1, wherein the display array is comprised of subpixels (b₀) wherein a width of each subpixel (b₀) is projected through a gap (S) of the parallax barrier to have a projection width (A) in viewing plane (Z), wherein the projection width (A) is smaller than 65 millimeters.

9. Method pursuant to claim 8, wherein the projection width (A) has a value which is smaller than 5 millimeters.
